(19) United States
(12) Patent Application Publication
(10) Pub. No.: US 2005/0021425 A1
(43) Pub. Date: Jan. 27, 2005

(54) Method and system for supply chain management employing a visualization interface

(76) Inventor: Liam Casey, Donoughmore (IE)

Correspondence Address: FENWICK & WEST LLP, SILICON VALLEY CENTER, 801 CALIFORNIA STREET, MOUNTAIN VIEW, CA, 94041, US

(21) Appl. No.: 10/846,497

(22) Filed: May 14, 2004

Related U.S. Application Data
(60) Provisional application No. 60/471,123, filed on May 16, 2003.
(60) Provisional application No. 60/532,481, filed on Dec. 24, 2003.

(51) Int. Cl. G06F 17/60

(52) U.S. Cl. 705/28

(57) ABSTRACT

Systems and methods for tracking various goods/services are disclosed. Status information is provided from a plurality of nodes on a supply chain to a database where it is stored in real-time. Suppliers, consumers, and intermediaries can access the information through a display that graphically and intuitively represents each of the plurality of nodes and the status data. By providing an end-to-end view of goods/services, embodiments of the invention allow users to efficiently track and manage various supply, procurement, and business processes.

### CROSS REFERENCE TO RELATED APPLICATIONS

This application claims the benefit of U.S. Provisional Application No. 60/471,123, filed May 16, 2003, which is herein incorporated by reference in its entirety. This application claims the benefit of U.S. Provisional Patent Application No. 60/532,481, filed Dec. 24, 2003, which is herein incorporated by reference in its entirety.

### BACKGROUND

1. Field of the Invention

This invention relates generally to supply chain management and specifically to methods and systems for tracking and managing the flow of raw materials, goods, or services from a supplier to a receiver.

2. Background of the Invention

The management of manufacturing inventory typically requires close coordination between various points in a supply chain. Raw materials and parts are sourced from multiple suppliers and locations, and steps in the assembly and manufacturing process may be carried out by different vendors or at different locations. Each non-redundant point in a supply chain introduces the risk of an additional resource bottleneck, leading to an overall delay in production. The inability to predict the status of various inputs into production can result in greater inventory carrying costs, parts surpluses, and a general loss in efficiency and responsiveness to fluctuation to demand, supply, or market conditions.

Conventional approaches to tracking the status of inputs to production are highly resource and time intensive. In order to monitor the status of parts or raw materials sourced from a supplier, a parts manager will commonly make multiple attempts to contact a supplier over the course of the procurement process, to determine, for instance, whether the ordered goods have been assembled or shipped, or if they are in transit. In turn, each point on a supply chain may have its own source of status information about open orders, increasing the tracking load. The number of times this exercise must be performed is further multiplied by the number of suppliers and parts that need to be tracked.

Existing solutions to the problem of order tracking are piecemeal and incomplete. Even if a manufacturer sources a component from a well-known supplier who can be relied upon to supply the ordered good within a certain time period, the manufacturer must often still depend on different vendors for delivery of the good, often via air, ocean, and/or ground transportation. And although portions of the supply chain may be automatically tracked, currently there is no way to tie disparate tracking systems and information together in a single information resource. Thus there is a need for unified systems and methods to track the status of production inputs from customer request to delivery of the requested goods or services.

### SUMMARY OF THE INVENTION

Embodiments of the present invention provide systems and methods of tracking the status of deliverables in a supply chain. Throughout the Specification, the terms “goods”, “services”, “inputs”, “deliverables”, and “goods/services” may be used interchangeably and are intended to encompass any good, service, raw material, or item with attributes or input to production. Graphically represented are nodes along a supply chain associated with, for instance, a supplier, a consumer, and intermediaries between the supplier and consumer including a broker of the product/service or shippers that provide transit services for the goods. Throughout the present disclosure, the term “supplier” includes a provider, sender, producer, or supplier of a good or service and the term “consumer” is used interchangeably with the terms “receiver”, “buyer”, “assembler”, “manufacturer” and can refer to any of these or other receiving entities. In addition, the term “intermediary” may refer to a shipper, transit provider, assembler, broker, buyer and seller, or other party providing services on a supply chain. In any given supply chain there may be one or more supplier, consumer, and intermediary nodes, each with varying levels of involvement in supplying, procuring and delivering goods/services.

In embodiments of the invention, one or more of these nodes may represent separate and unaffiliated entities sourcing data from separate and unaffiliated sources. For instance, in the supply chain of a part that is sourced from two different parts suppliers who are in fact competitors, in embodiments of the invention, status data is sourced from both of them. Likewise, a transit supplier covering a route in one part of the world may be a wholly separate from and unaffiliated with a customer whose goods are shipped using the transit supplier's services. Embodiments of the invention enable data from these different sources to be aggregated in a central database, thereby bringing together in a common location data from disparate sources that are customarily tracked separately.

In an embodiment, there is a tracking system for monitoring the status of goods or services being provided to a receiver from a supplier. The system comprises a database of information about the goods/services that describes the status of the goods/services at various nodes in a supply chain. In addition, a display system is provided to access the database, retrieve status data, and generate a single-screen display that graphically represents each of the nodes and status associated with each node based on the data. In various embodiments of the invention, template creation, display management, event, and data modules are also provided. In addition, embodiments of the invention allow pre-defined “events” or conditions to be detected based on the status data, and for provide for the performance of an action when the event or condition occurs.

In another embodiment, a display is provided for depicting stages in a process. The display comprises graphical representations of a plurality of stages in the process wherein the specific status of the process at each stage is visually depicted with reference to a quantitative value. It also includes a table of values associated with one stage in the process. Activation of the graphical representation within a certain stage causes the values in the table to change to reflect values within the selected stage.

Although primarily described in the context of the context of supply chain management and goods, the present invention can be applied broadly to the fields of order management, customer relations management, and enterprise resources planning.

### BRIEF DESCRIPTION OF THE DRAWINGS

FIG. 1 is a graphical representation of a tracking display in accordance with an embodiment of the invention.

FIG. 2A is a system diagram of a tracking system in accordance with an embodiment of the invention.

FIG. 2B is a block diagram of a tracking system in accordance with an embodiment of the invention.

FIG. 2C is a block diagram of a computer memory in accordance with the tracking system of FIG. 2A.

FIG. 3 is a flow diagram of a process for tracking a display in accordance with an embodiment of the invention.

FIG. 4A-4C show graphical representations of assorted embodiments of tracking displays in accordance with the invention.

FIG. 5 is a graphical representation of a catalogue display linked to a tracking display in accordance with an embodiment of the invention.

FIG. 6 is a catalogue display linked to a parts display linked to a tracking display.

FIG. 7 is a graphical representation of a dashboard display depicting the status of various parts in a supply chain for use in an embodiment of the invention.

FIG. 8 is a graphical representation of a user interface for managing data retrieval and display preferences for generation of a tracking display in accordance with an embodiment of the invention.

FIG. 9 is a graphical representation of a user interface for managing data feeds to source a tracking display in accordance with an embodiment of the invention.

FIGS. 10-13 are graphical representations of user interfaces for managing data sources and data feeds for a database for storing status data to be output to a tracking display in accordance with an embodiment of the invention.

FIG. 14 shows graphical images for use in a tracking display in accordance with embodiments of the invention.

FIG. 15 is a flow diagram of a process for detecting an event in status data and performing an action upon the detection of an event in accordance with an embodiment of the invention.

FIG. 16 is a flow diagram of a process for creating a status display template in accordance with an embodiment of the invention.

### DETAILED DESCRIPTION OF THE PREFERRED EMBODIMENTS

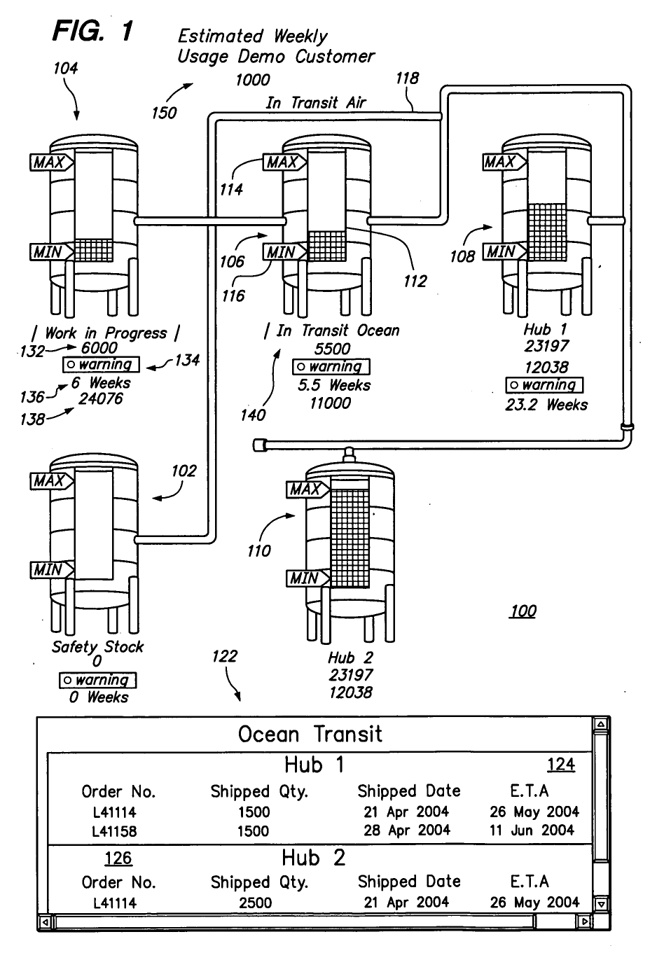

FIG. 1 is a graphical representation of a tracking display 100 for monitoring the status of the inputs into the production of goods in accordance with an embodiment of the invention. While the present invention will now be described in term of a supply chain for goods, those skilled in the art will recognize that the present invention also applies to various other aspects of systems needing monitoring and reporting capabilities including but not limited to services, health care, and power generation. Moreover, while the present invention will be described below in specific contexts with set number of suppliers, intermediaries, and consumers, for ease of explanation and understanding, these numbers are provided only by way of example, and embodiments of the invention may comprise less or fewer or none of a supplier, intermediary and consumer.

Tracking display 100 graphically depicts five tanks 102-110 representing five nodes on a supply chain extending from a supplier node tank 102 to a receiver node tank 110. Each node is intuitively represented by an image of a holding tank 102-110 connected by grid 118 to other holding tanks 102-110. The stock level at each node is graphically depicted as liquid in a tank (see, e.g. level 112 in transit ocean tank 114). Diagnostic data and indicators 132-138 appear below each tank 102-110, and further detail supporting the data for a selected tank 102-110 is provided in table 122. By depicting status data in an intuitive and simple way, the embodiment of the invention shown in FIG. 1 offers a detailed summary of the current status of a supply chain across various nodes in an uncrowded single-screen tracking display 100. While each node is described in the preferred embodiment as a tank holding a number of goods, those skilled in the art will recognize that any number of other symbols may be used to convey the same data and information. Various alternate embodiments will be described below.

The deliverable being tracked in tracking display 100 of FIG. 1 can represent any of a variety of goods, services, or production inputs. For instance, in the sourcing of parts for a hand-held device, tracking display 100 of FIG. 1 could be used to track the procurement of a variety of components to be assembled into a finished product. In another embodiment, tracking display 100 can depict the procurement of other goods/services or various business or other processes, or may be used for other applications such as tracking the status of a workflow.

The status data shown can comprise any measure of an input's status including the quantity or volume of the input, measured by weight or number of units, or other measure appropriate to the input being monitored. Status data may reflect a measure of time such as the number of weeks' worth of a supply of an input at a given consumption rate. Status data can also include qualitative information such as warning or informational messages sent from a node to a user, indications of significant events, or other information. It can also comprise financial or market information about the input, such as its price, the cost of shipping the input, or demand for the input, or convey another measure of cost, price, or value. The status data presented can be associated with any grouping or sub-unit of inventory, reflecting the inventory associated with, for example, all of the open orders for a customer for a particular part, or a stock category, for instance, all power cords, associated with a particular user.

Display Views

What portion of tracking display 100 a requesting user sees may depend on the identity and preferences of the user. For instance, in an embodiment, a supplier, intermediary, supply chain manager, and consumer may each have access to data about different parts of the supply chain depending on their role. In one scenario, a supply chain manager is tasked with procuring production inputs to a consumer through various suppliers and intermediaries. The supply chain manager contacts various suppliers to provide the production inputs, and also locates various transit providers to ensure delivery of the goods to the consumer. The supply chain manager logs into a portal and requests tracking display 100 by linking to the page. Because she has responsibility for the end-to-end process, and is responsible for intervening as required, supply chain manager, in an embodiment, receives access to the full view of tracking display 100 including diagnostic and other information.

A consumer on the other hand may only receive a view of the consumer's receiving nodes, e.g. Hub 1 108 and Hub 2 110 in FIG. 1. A consumer may not want to see the front end of the supply chain given that she has purposely outsourced management to supply chain manager. In addition, supply chain manager may not want consumer to see warning messages associated with faults in the supply chain. Similarly, an intermediary may receive views of its respective location, e.g. in transit ocean tank 106. Alternatively, an intermediary or another party may also receive views of surrounding nodes, or can access to data across the entire chain. In another embodiment, third-party suppliers or intermediaries who are not involved in the transaction may also gain access to portions of tracking display 100 in order to offer gap filling services on an as-needed basis. The information accessible by a third party may be presented in a different, abbreviated view so as to conceal the identities of the parties experiencing the shortfall.

Views can also differ by the flow and nature of a good or goods being tracked. For instance, a consumer or receiver's view of tracking display 100 may reflect an aggregation of all open orders associated with a specific good ordered by the consumer, which may include various different inputs, for delivery to one or more hub locations of the consumer. Where multiple inputs are being ordered and tracked, for instance, multiple tanks, each representing an input, may be displayed. A supply chain manager, on the other hand, may want to focus on one particular order from a consumer, which it may source from multiple suppliers, or it may want to view status by supplier, or by good. Using a variant of tracking display 100 of FIG. 1 a supply chain manager may be able to compare the performance of different suppliers providing the same good, or track the status of multiple goods from a single supplier. Other views, depending on the user's needs, are also possible. Each different user may also have certain preferences or settings, specifying for instance the format and content of display 100 which also impact the output 100 seen by the user.

Display Features

The first two tanks 102, 104 in tracking display 100 of FIG. 1 represent supplier nodes. Work In Progress tank 104 represents the quantity of a specific part currently under manufacture and Safety Stock tank 102 represents a reserve quantity of a specific part that is set aside for potential delivery to a supplier. In Transit Ocean tank 106 represents an intermediary node, and reflects the quantity of the item currently in ocean transit. Other supplier and transit nodes could be represented as well including land or air transit, or a shipping hub, for instance. Although each of these nodes represents a distinct step in the supply chain, in other embodiments, multiple redundant nodes at various stages in the procurement process may be depicted as alternative paths in a chain, for instance, as shown in FIG. 1 in the case of the two hub tanks, Hub 1 tank 108 and Hub 2 tank 110.

The fourth and fifth tanks 108, 110 in tracking display 100 represent two customer receiving hubs respectively, Hub 1 and Hub 2. In other embodiments, additional hubs may be associated with the ordered input, represented by additional tanks placed adjacent to Hub 2 tank 110. Below each hub's tank are additional display subsections reporting diagnostics similar to those described above.

Underneath each of tanks 102-110 are various display subsections for conveying diagnostic and quantitative data. Appearing directly below Work In Progress tank 104, for instance, are four display subsections 132-138. First subsection 132 presents the total quantity of the ordered part across different open orders from the local hub. Also included in the display 100 is a display area 150 for presenting an estimated weekly usage value associated with a user. This estimate could be determined according to any of a variety of inputs including a historical average, user-specified estimate, or forecast based in part on a specified growth rate. Any assumptions used to calculate such diagnostic data, for instance regarding an assumed growth rate, may be displayed on or accessible by a link from display 100. Second subsection 134 comprises a warning indicator that will flash if tank's 104 maximum threshold is exceeded or the input level falls below a minimum threshold or if any other pre-defined rule has been broken or trigger activated. In an embodiment of the invention, when a user holds a mouse pointer over a flashing indicator in second subsection 134 of display 100, further information is provided regarding the reason for the warning.

Third subsection 136 displays the projected number of weeks of supply the tank 104 is presently holding given the estimated weekly rate of usage 150 as shown. Those skilled in art will recognize that any number of other measures may be used to draw the users attention to a warning or fault condition such as but not limited to use of color, outputting a sound, or other user interface mechanism. Fourth subsection 138 sums together the quantities of current W.I.P. orders across associated hubs.

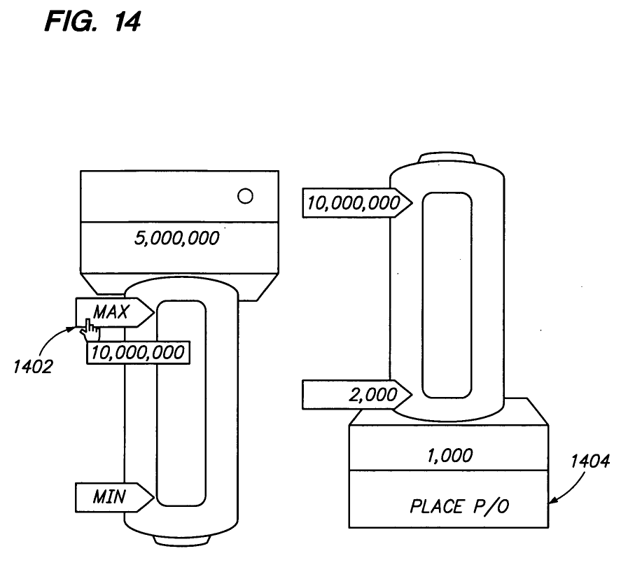

The amount of goods available at each node is depicted in relation to pre-defined minimum and maximum thresholds, demarcated using arrows 114 and 116 on each tank 102-110. As shown in FIG. 14, minimum and maximum thresholds may be displayed when a user holds a pointer 1402 such as a mouse over a tank's 102-110 minimum 116 and maximum 114 signs. The minimums 116 and maximums 114 selected for use in each tank 102-110 may reflect a variety of values, such as historical thresholds, capacities, contract terms, or other measure.

Tanks 102-110 may be sized on equivalent or different scales. In an embodiment, tanks 102-110 are drawn to scale based on the maximum threshold, so that facilities with larger capacities are shown as larger than other facilities. In embodiments of the invention, more than one node is associated with the same stage of procurement or production, for instance if there are a multiplicity of supplier nodes in a supply chain, each associated with a supplier performing the same function of providing the ordered good. Two such redundant nodes can be represented in a variety of ways including in the form of two supplier tanks, or one tank with two different portions representing each supplier, or two smaller tanks represented in small column or space designated for “supplier” nodes, or some other variant based on display techniques well known in the art.

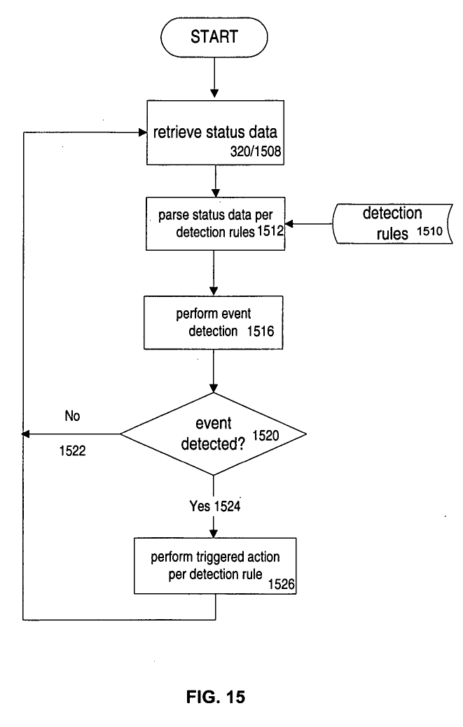

Broadly speaking, embodiments of the present invention allow for the detection of “events” or “conditions” based on status data and the taking of a corresponding action based on the event or condition. A user may define an event or condition in terms of any quantity or quality of any measure of status data, including with reference to raw data, a calculated value, or a designated threshold, such as the days in transit, remaining supply, or total dollar amount of an order. If an event or condition has been detected, in embodiments of the invention, an action may be performed by the tracking system, including placing a warning or other message on display 100. For instance, in the embodiment of tracking display element shown in FIG. 14, a “Place P/O” signal 1404 alerts the user to the need to place a purchase order when the level of inventory at a node drops below a certain threshold. Other actions not related to tracking display 100 may be automatically triggered. Such actions could include the sending of an automatically generated email, instant message, fax, or other message to the respective party or parties responsible for correcting or monitoring the event. It could also comprise a notification tone or alarm. Event detection and performance of triggered actions is discussed below with reference to FIG. 15.

Display 100 can convey a wide variety performance or internal tracking information about the supply of an input. For instance, in a supply transaction, metrics such as sale price, quality, quantity, and on-time delivery may all represent measures upon which to evaluate different suppliers or intermediaries. Information about a particular party's performance with respect to such metrics may also be presented on display 100, in the form of quantitative or qualitative information such as “remaining days to contract date”. Moreover, in alternate embodiments of the inventions where production is not associated with a particular contract, but rather sold to a wholesale market, any of a number of pre-determined conditions may be used automatically to adjust the price at which the goods are being sold to a consumer or receiver. Once an event based on a pre-determined condition is detected and diagnostic information or a message is generated, display 100 or other medium can be used to convey this information or message. For example, a message may be produced by an automatic email generator well-known in the art, addressed to a pre-specified address, and then sent through a signal line through a network interface to the internet and routed to the alerted party. In another embodiment, a message is sent through a signal line to a monitoring server hosted on a network. Other output techniques well-known in the art may alternatively be used. This functionality can enhance a party's ability to provide real-time price adjustment based on availability and predicted availability of the goods.

As discussed throughout this application, the term “signal line” includes any connection or combination of connections supported by a digital, analog, satellite, wireless, firewire (IEEE 1394), 802.11, RF, local and/or wide area network, Ethernet, 9 -pin connector, parallel port, USB, serial, or small computer system interface (SCSI), TCP/IP, HTTP, email, web server, or other communications device, router, or protocol. In some cases, “signal line” may also comprise a conventional phone line, for instance, used by a supplier to call in real-time status data from a node. In certain cases, signal line facilitates bi-directional communication, or in other cases, may only support unidirectional communication.

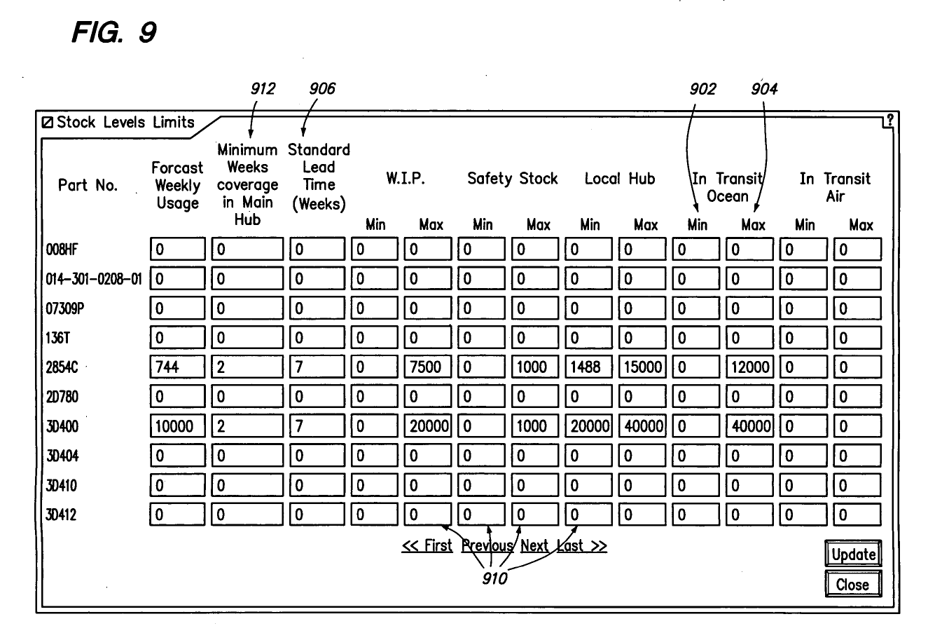

Users may specify the values that define events or conditions upon which an action will be performed, and the resulting action triggered by the occurrence of the event or fault condition. As discussed in connection with FIG. 9 below, in an embodiment, a user can specify the values and rules that define events, and also supply the actions to be carried out.

Display 100 of FIG. 1 includes table display area 122 for showing numerical order and shipping data. Table display area 122 provides additional detail to complement the inventory information depicted graphically in In Transit Ocean tank 106. In Transit Ocean tank 106 of FIG. 1 contains 5500 units of input. Table display 122 further breaks this down into two orders as shown: order numbers L41114 and L41114. Portions of each order are bound for one or more of two different hub locations, Hub 1 and Hub 2. Within table display 122 are shown two sections 124 and 126, each representing a hub location.

A user can access table display 122 shown by clicking on a subsection of In Transit Ocean display 140, and scroll through the table 122 such that detailed order information (and the full supply chain) can be accessed in conjunction with the view of the supply chain presented by tanks 102-110 on grid 118. In an embodiment of the invention, table display 122 associated with W.I.P tank 104 details each open order's number, the quantity of the part ordered, the quantity of parts already shipped, the open quantity, the date on which the open quantity is expected to ship and the date on which it is expected to arrive. In an embodiment, the table display associated with either of Hub 1 tank 108 and Hub 2 tank 110 reports hub open order quantity value, each order number, the order quantity, the quantity issued to date, the remaining open quantity, and the date on which the last quantity was issued. In this way, highly granular information can be presented to a user on an on-demand basis, allowing a user to pinpoint specific information quickly and intuitively without having to sift through tables of data or traverse many websites.

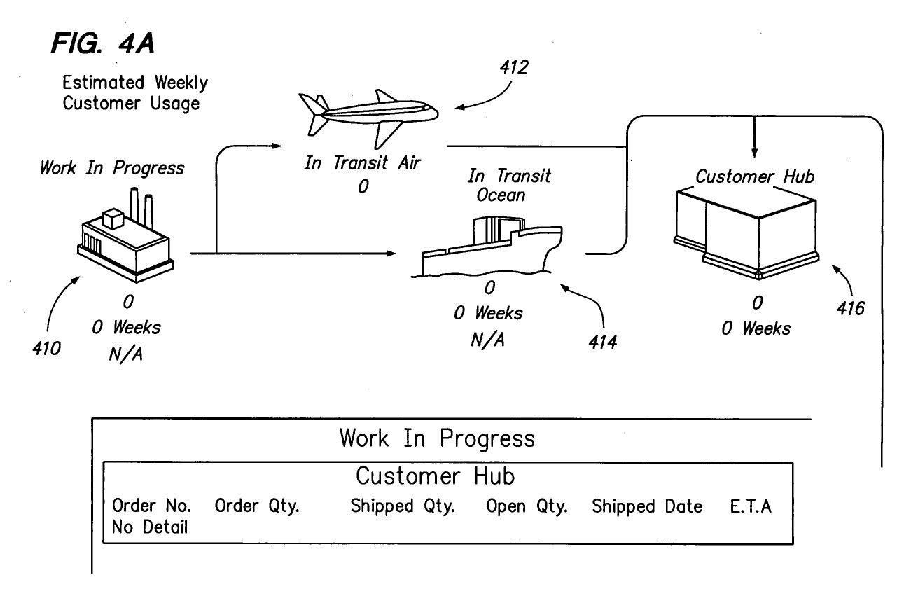

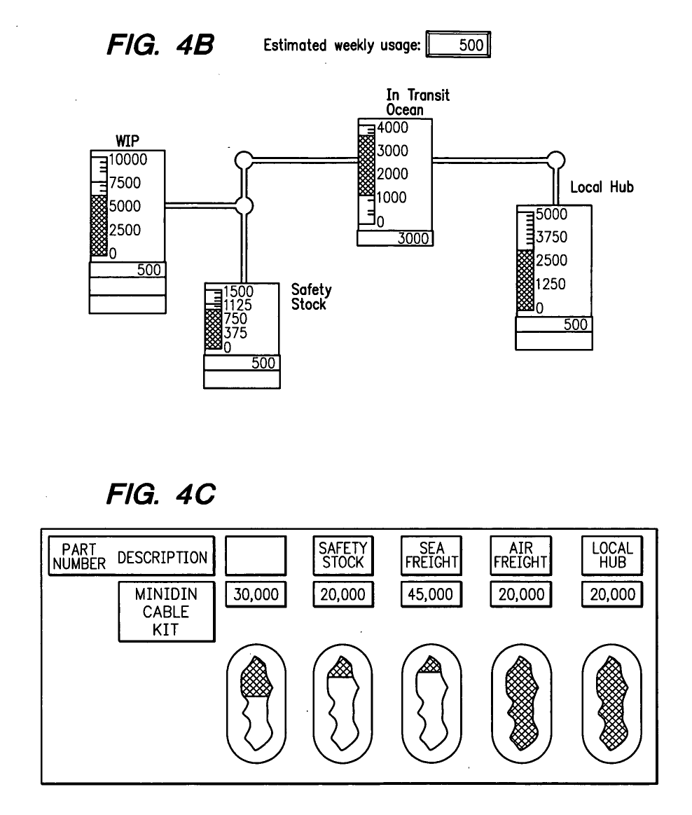

As known by one of ordinary skill in the art, a wide variety of illustrations and display selections may be used to implement embodiments of the present invention. For instance, rather than using tanks, graphical images of batteries, as shown in FIG. 14, could be used. Alternatively, status data could be presented numerically rather than graphically, while the nodes themselves could each be presented by a different image distinctly associated with each node. The illustrative display shown in FIG. 4A, for instance, includes a factory image for a work in progress node, an airplane image 412 for an in transit air node, a steamliner image 414 for an in transit ocean node, and a distribution site 416 for a hub node. Underneath each graphical image, various status or diagnostic data is presented in the form of the numerical quantity of the input. FIGS. 4B and 4C present other embodiments of a tracking display in accordance with embodiments of the present invention. In FIG. 4B, levels of input are graphically shown as being measured against yardsticks, and numerical values are included underneath each node. In FIG. 4C, each node is represented as an elongated pod, with shading of the pod used to indicate the status of the input.

System Architecture

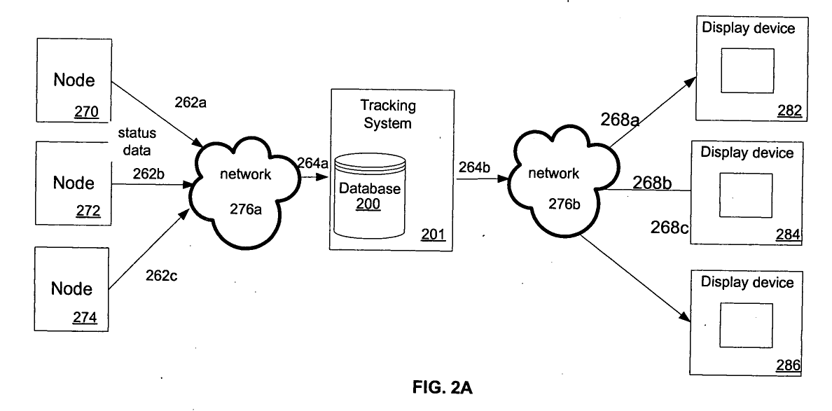

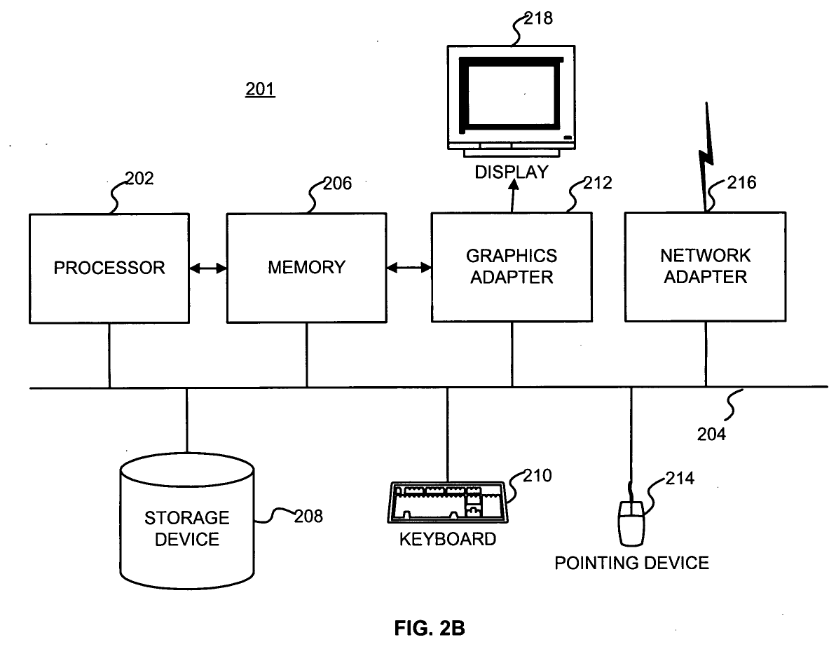

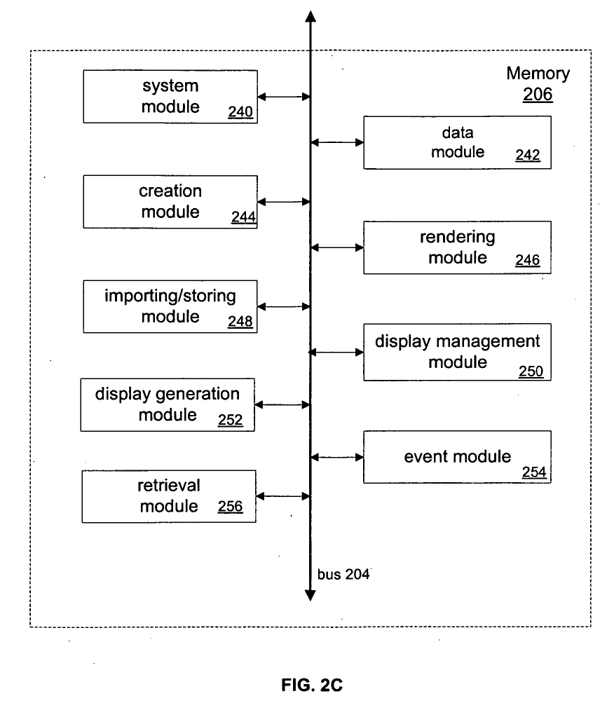

The displays and display components of FIGS. 1, 4A-C & 14 can be generated using a variety of methods. FIG. 2A is a block diagram showing tracking system 201 for generating display 100 in accordance with an embodiment of the invention. System 201 includes database 200 that receives status data from various supply chain nodes 270-274 over signal lines 262, 264a and through network 276a. Nodes 270-274 comprise points in a supply chain, including the points associated with an order system, a temporary storage repository, transportation vessel, or other location on a supply chain. Status data can be collected from a node 270-274 manually, detected electronically using a sensor or other monitoring mechanism, or determined using a combination of methods. The data is sent through network 276a and signal lines 262, 264a to database 200. In response to a request for data, status data is retrieved from database 200 using a processor. The data is used to generate a display, such as display 100 of FIG. 1. Over signal line 264b, through network 276b, and through signal lines 268, the display is output upon various display devices 282-286.

Database 200 comprises a repository of data that could take the form of any of a variety of conventional data structures including a relational database management system (“RDBMS”), lightweight data access protocol (“LDAP”) server, or flat files. In an embodiment, the status data is stored in a SAP Fourth Shift database 200, hosted on a server (not shown). As will be described in greater detail, in an embodiment, the data is imported into database 200 from a data feed formatted in XML exported from the supplier's own system (not shown). In an embodiment of the invention, status data from one or more supplier nodes 270-274 is sent to database 200 on a regular interval, such as every half an hour or several times a day.

FIG. 2B is a block diagram of tracking system 201 in accordance with an embodiment of the present invention. One or more of the elements shown in system 200 of FIG. 2A however, may also be hosted on a computer system that includes one or more of the typical computer system elements depicted in FIG. 2B. Illustrated are at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

The processor 202 may be any general-purpose processor such as an INTEL x86, SUN MICROSYSTEMS SPARC, or POWERPC compatible-CPU. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, or other type of pointing device, and is used in combination with the keyboard 210 to input data into the computer system 220. The graphics adapter 212 displays images and other information on the display 218. The network adapter 216 couples the computer system 220 to the network.

As is known in the art, the computer system 220 is adapted to execute computer program modules for providing functionality described herein. As used herein, the term “module” can refer to computer program logic for providing the specified functionality. A module can be implemented in hardware, firmware, and/or software. Preferably, a module is stored on the storage device 208, loaded into the memory 206, and executed by the processor 202.

The types of hardware and software within the computer system 220 may vary depending upon the implementation of the tracking system. For example, a tracking system operating in a high-volume environment may have multiple processors and hard drive subsystems in order to provide a high processing throughput, as well as multiple displays and keyboards in order to support multiple simultaneous users. Likewise, certain embodiments may omit certain components, such as the display 218, keyboard 210, and/or network adapter 216 depending upon the specific capabilities of the system. In addition, the computer system 220 may support additional conventional functionality not described in detail herein, such as displaying images in a variety of formats, allowing users to securely log into the system, and supporting administrative capabilities.

In FIG. 2A, tracking system 201 includes database 200 and is coupled to nodes 270-274 and display devices 282-286 through signal lines 262-268 and networks 276. In an embodiment, modules of tracking system 201 and database 200 are hosted on a common server or computer system, while in others, various processing, database, and other functions are carried out by different modules, carried out on different devices or systems which may be coupled to each other through various networks and wireless or wireline connections. In addition, it is not necessary for every embodiment of the invention to include all of the elements depicted or be coupled as shown. In some implementations of the system, the various elements may also appear in different configurations.

System Modules

FIG. 2C is a block diagram of computer memory 206 of tracking system 201 of FIG. 2A. Although computer memory 206 will be discussed with reference to tracking system 201 of FIG. 2B, one of ordinary skill in the art will know that the modules referred to may be stored or hosted in configurations other than that shown or described.

Memory 206 is coupled to tracking system 201 of FIG. 2B including processor 202 by way of bus 204, and may contain instructions and/or data for carrying out any and/or all of the processing functions accomplished by tracking system 201. Memory 206 is comprised of main system module 240 and assorted processing modules 242-256 and is coupled to processor 202 and database 200 of tracking system 201 by bus 204. Main system module 240 serves as the central interface between database 200, the other elements of tracking system 201, and modules 242-256. In various embodiments of the invention, main system module 240 receives input in the forms of information or commands. Main system module 240 interprets the input and activates the appropriate module 242-256. System module 240 may also retrieve the relevant data from memory 206 and pass it to the relevant module 242-256. The respective module 242-256 processes the data, typically on processor 202 or another processor, and returns the result to system module 240.

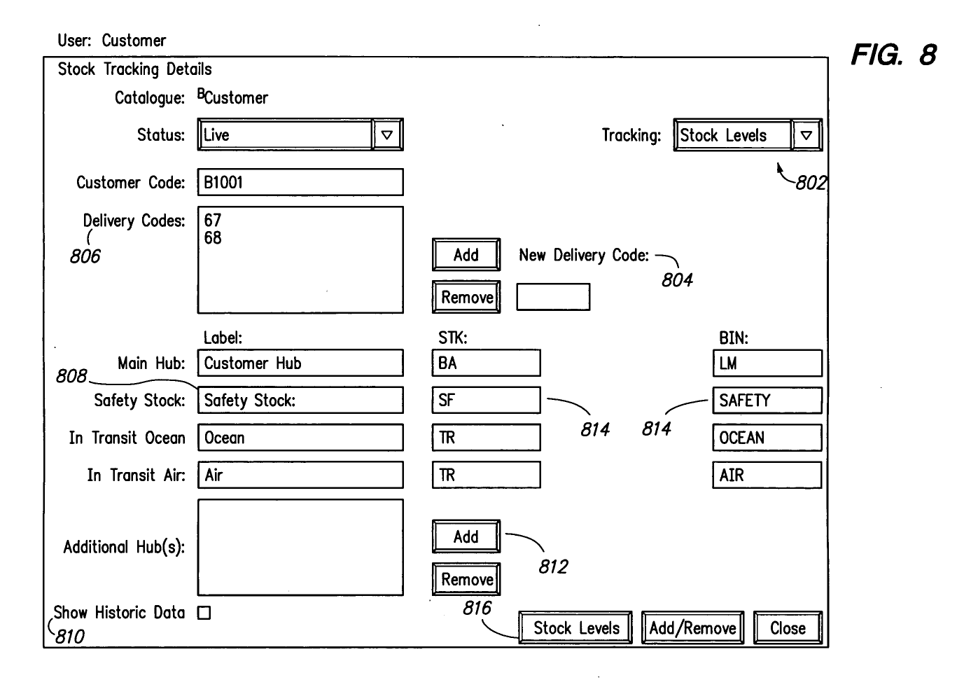

Creation module 244 is coupled to system module 240 by bus 204. In the operation of tracking system 201, user input concerning significant nodes, the flow of goods/services between them, the node labels, and various display output options may be provided to system module 240 as described in detail below with reference to FIGS. 8-13 and 16. System module 240 in turn provides the input by bus 204 to template creation/editing module 244. Creation module 244 uses this input to generate an output template to be populated by various data sources on processor 202. As described below, this template may include placeholders for raw and processed status data and messages or information based on the status data.

Importing/storing module 248 is coupled to system module 240 and database 200 by bus 204. As shown in FIG. 2A, status data is provided from various nodes (e.g. nodes 270-274) to tracking system 201 by way of signal lines 262, 264a and network 276a. The data feed is sent to system module 240 over bus 204. System module sends a signal to importing/storage module 248, which then sends commands to processor 202 directing the data to be saved to database 200.

Display generation module 252, retrieval module 256, data module 242, rendering module 246, and event module 254 are coupled to system module 240 and database 200 by bus 204. When it receives a request, tracking system 201 generates a status display to be viewed on various devices 282-286. The request is received by system module 240 that in turn routes activates display generation module 252, signaling that a request has been made. Display generation module 252 in turn activates retrieval module 256, which formulates and sends commands to processor 202 to retrieve the required data from database. Display generation module 252 can also access instructions and user preferences, user stored in memory 206, about how to create the display to be output. Once the data has been retrieved by retrieval module 256, display generation module 252 activates data module 242 to transform the raw data into a useful output. This analysis may involve parsing or formatting the data, or analyzing values in the data against a predefined rule in order to determine whether an event or condition has occurred. If an event has been detected, a signal is sent to event module 254. Event module 254 accesses information stored in memory 206 that specifies what action if any should be taken. As described below with reference to FIG. 15, the action could comprise adding a warning message to an output, or another action.

Display generation module 252 activates rendering module 246. Display generation module 252, can instruct rendering module 204 to transform data processed by data module 242, user preferences, and/or event data into a displayable page such as in Hypertext Markup Language (HTML) or other well-known format.

The displayable output produced by rendering module 246 is viewed by a user. When a user provides an input based on the display, such as clicking in a section of the display, the input is sent to display management module 250, which may then execute any of a number of options including causing more detailed information to be displayed. For instance, display management module 250 could generate a pop-up or interstitial window containing additional detail or other information or even additional status data or information about the availability of other suppliers. In another embodiment, display management module 250 could launch a messaging interface such as a Messaging Application Programming Interface (MAPI) in which a pre-populated email message referring to or including status or diagnostic information could be created. Later, when the user wants to edit or change the display, including by changing the number of nodes or the data feed source, editing functionality provided by creation module 244 or other modules can be used to accomplish this task.

Creation of Tracking Display

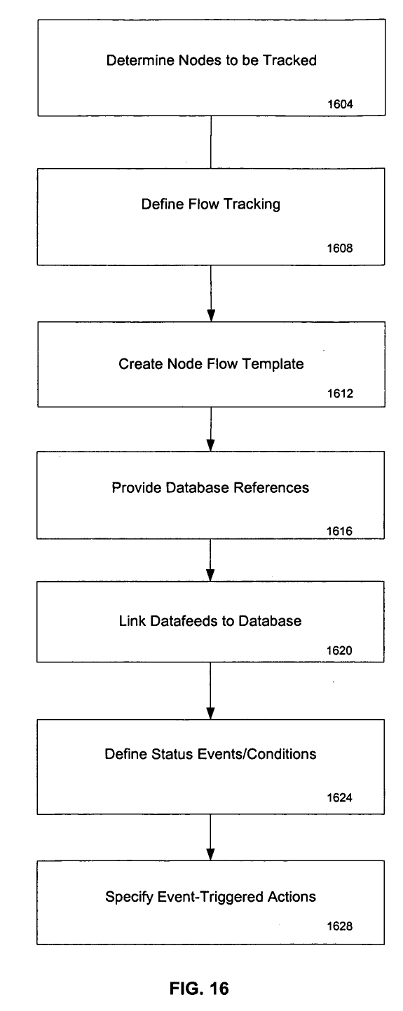

A process for creating a template for a display 100 with tracking system 201 of FIG. 2A in accordance with an embodiment of the invention is depicted in FIG. 16. Those of skill in the art will recognize that alternative embodiments of the system may perform the illustrated steps of this or other processes described herein in different orders, perform additional steps, or omit certain steps.

Take for example the case of a supply chain manager, who is requested by a manufacturer to source parts to fulfill an order for hand held devices. The manufacturer specifies that he requires, among other things, a form factor chassis, LED screen, power supply, and device case for each unit he will manufacture. In an embodiment, the supply chain manager places several orders over the course of a few weeks for screens from a supplier. After the screens are ordered, the suppliers assemble the screens, then ship them in batches from each suppliers' factory or other facility (the supplier could in turn source them from another manufacturer in an embodiment) via ocean transit to various ports. The ports are located near the end user two hubs, for distribution to the factories where the manufacturer will assemble the parts into finished goods.

The display template to match this order flow is first created. Turning to FIG. 16, the supply chain manager or other party determines 1604 the nodes of significance on the supply chain to be tracked. These nodes could include, for instance the screen suppliers' factory and shipping facilities, various transit nodes, and the manufacturer's two hubs. The supply chain manager then defines 1608 the flow of goods between the nodes. For instance, the paths of screens provided by different suppliers, which diverges at their origin, may join at various points such as transit nodes or the manufacturer's hub.

The graphical user interface of FIG. 8 can be used by the supply chain manager to define the nodes and the flow of goods between nodes using input windows and pull-down menus. The nodes can be identified and labeled on the interface as shown, for instance safety stock 808 provided with the label “Safety Stock.” Hubs can be identified with input window and add hub button 812. The supply chain manager can input delivery options in a delivery code input window 806 with the help of an add delivery code button 804. In addition, the supply chain manager can select a type of tracking output 802 (for example “stock levels” or “basic tracking”) associated with a pre-determined set of graphical images and configurations. In an embodiment, there is a “stock level” configuration option is associated with the template depicted in FIG. 1, including the tanks 102-110, grid 110, table 122 and various subsections 132-138 shown. In an embodiment, a “basic tracking” option is provided that outputs information in the simplified format shown in FIG. 4A, wherein quantity information is provided only numerically and not graphically. Returning to FIG. 16, all of this data is used to create 1612a node flow.

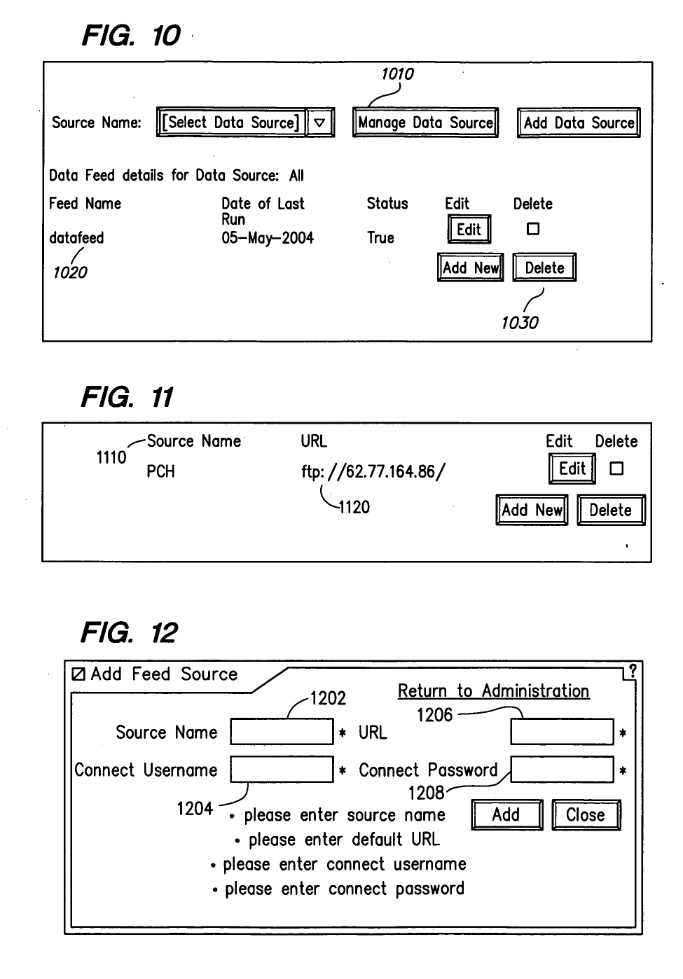

After identifying the various nodes and choosing among configuration options, the user may provide 1616 database references to enable the data behind each node to be retrieved. By entering database tags and fields into input windows 814, a user can reference database locations for instance. This information, in turn, can be stored and used to generate the database queries used to source the status data of each node displayed. The supply chain manager or other user may then specify the sources of data that will be provided and stored to database 200. For each of these nodes, a source of status data is identified and commonly will comprise the existing tracking system or database of an individual supplier, transporter, or other link in the supply chain. Using the graphical user interfaces of FIGS. 10-13, described in detail below, a supply chain manager or other user can link 1620 data feeds to database 200.

Finally, the user can define 1624 status events/conditions and specify 1628 what action or actions should be taken upon detection of an event or condition. FIG. 9 provides one interface for defining such events or detection rules. As shown in FIG. 9, various input areas 910 are available to a user to set for instance, the minimum number of weeks of coverage required in a hub 912, the standard amount of lead-time 906, or threshold minimum 902 and maximum 904 values. By inputting these values a user specifies “detection rules” and fault conditions that define bottleneck situations in which an alert action should be generated. For instance, if inventory in a local hub drops below the product of the forecasted weekly usage and the minimum weeks of coverage needed at a hub, a user can receive a warning indicator, either graphically or alternatively in the form of an email or other communication.

Use of Status Tracking System

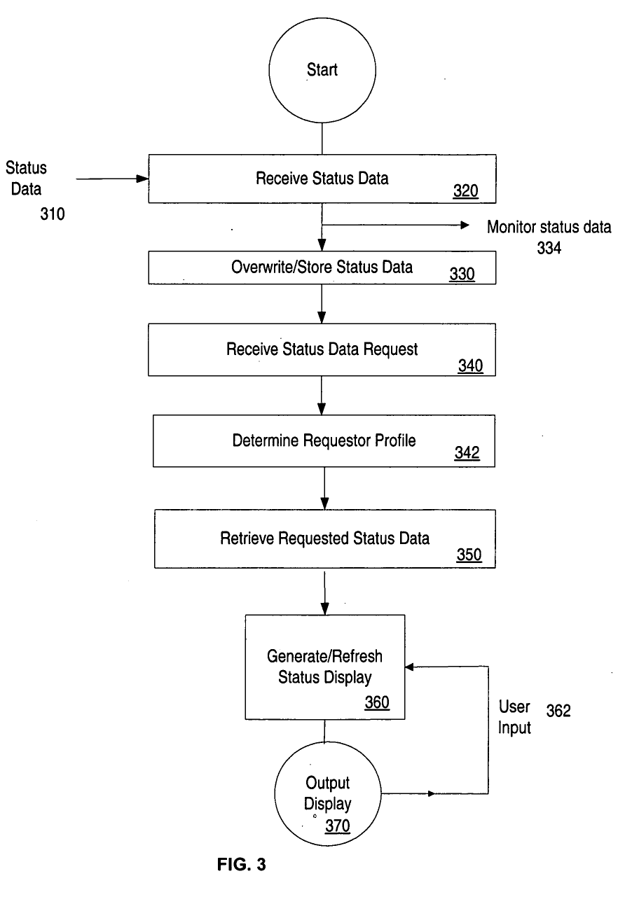

Once a display template has been created, tracking system 201 of FIG. 2A can be used to track the status of a flow of goods across the designated nodes. The flowchart of FIG. 3 describes a simple process for populating a status database using a tracking system 201. Continuing with the screen procurement scenario discussed above, the process begins with receipt 320 of status data by tracking system 201 from various supplier, intermediary, and manufacturer nodes indicating the quantity of screens or other status data at each node. In an embodiment, this status data 310 is provided and refreshed in real-time and stored or overwritten 330 to database 200. The data may be sent in an XML, Web Services, or other file format and will generally include order and customer information by which the data will be indexed. At some point, the supply chain manager or manufacturer or another party seeks to track the status of the screens. To do so, the user can call up a user interface on a web or other network browser, for instance, which in turn generates a request for status data from the database.

This status data request is received 340 by tracking system 201. Tracking system 201 determines 342 the profile of the requesting party, based on log-in or other information, and in an embodiment, proceeds to formulate a request to database 200 based on this profile. As discussed before, a manufacturer or intermediary may only receive access to a portion of the supply chain, whereas, in an embodiment, a supply chain manager is provided access to all of the status data. In an embodiment, the requesting party can also specify the view of the data they would like to see, for instance, data associated with different users and different levels of status data aggregations, for instance at the customer, purchase-order, or node level. Responding to these various inputs, tracking system 201 processes the request, and the requested data is retrieved 350, for instance by database calls implemented by a processor on the same server as the database 200, although other modules could perform one or more of the steps described herein.

Based on retrieved status data a status display is generated 360. In the process depicted in FIG. 3, a user's display preferences as well as status event/condition information such as a maximum order values are used in combination with the status data to generate an output display 370. In an embodiment, the display 370 is generated in the form of display code sent through signal lines 208 and a network 216 to the requesting device or server (not shown), and translated into an output display 370 such as the tracking display 100 of FIG. 1. The display code may be implemented via a web browser in an embodiment, although other suitable graphical formats and presentations may be adopted in alternative embodiments. The resulting display 370 can be exhibited on display devices 222-226 accessible to requesting party. In another embodiment of the invention, the output display 370 is sent to a processing device and rendered on a screen such as that of a handheld device, laptop, desktop, or other machine or device.

After the output display 370 is initially provided, user input 362 may be provided to tracking system 201 based on the output display 370. This input 370 can be in the form of commands signaled by clicks, motions of a pointer, activation of a portion of a touch screen, or other input 632. In an embodiment, tracking system 201 refreshes 360 output display 370, for instance showing a more detailed view or launching a window containing definitions or additional status information, based on the user input 370. In another embodiment, a messaging interface can be launched by the user by which a user can instantly send an email or other message to another party on the supply chain.

As shown in FIG. 3, in operation, tracking system 201 may also be used to monitor 334 status data for the occurrence of certain events. As shown, such monitoring takes place whenever status data is provided to database 200, regardless of whether or not there is a request for data. FIG. 15 is a flow chart of one process for conducting event detection and performance of a triggered action in accordance with an embodiment of the invention. Table 1 provides some examples of hypothetical events and the actions they would trigger.

TABLE 1

| Event | Description | Rule | Action if Event |
|---|---|---|---|
| “Level 1 | Delivery in delay | If DDelay => 5, | Send message to |
| Delivery | to Hub of any | If DDelay <= 10, | supplier claiming |
| delay” | input by 5-10 days. | Level 1 Delivery | 5% discount. |
| | | delay. | |
| “Low | Hub Inventory | Threshold = t | Create PO form, |
| Inventory | drops below | Inventory at Hub < | send message to |
| at Hub” | certain threshold | t, Low Inventory at | supply chain |
| | | Hub | manager |
| | | | enclosing same. |

As shown in FIG. 15, the process begins when status data is received 320/1508. The new data is saved to database 200. The new and existing status data is parsed 1512 according to pre-defined event detection rules 1510 that specify what specific data is needed to perform analysis based on the relevant rule. Tracking system 201 performs 1516 event detection to determine whether an event as pre-defined by event detection rules 1510, as shown in Table 1, has occurred. If an event has been detected 1524, tracking system 201 proceeds to perform 1526 the action associated with the event as defined by the event detection rule (e.g. to send a message to a supplier claiming a 5% discount if a Level 1 Delivery delay is detected). After this action has been performed 1526 or if an event has not been detected 1522, tracking system 201 continues to monitor status data.

Management of Tracking Data

Displays of FIGS. 10-13 can be used to manage the supply of data from the nodes 210-214 and database 200 of FIG. 2A. In an embodiment of the invention, a specific feed associated with a data source supplies status data from a particular node 210-214 to the database 200. In FIG. 10, a data feed associated with a data source that contains status information from node 210-214 is identified by name (“datafeed”) 1020 in a simple interface. Information is provided on the display regarding the current status (“status”) and most recent time of access (“date of last run”) to the datafeed 1020. Using the display of FIG. 10, a user or administrator can edit or change data sources 1030 or feeds by activating various user interface buttons 1010, 1030. If a user would like to manage a data source, she can do so by activating the “manage data source” button 1030, which in an embodiment of the invention leads to the display of FIG. 11.

Identified in the display of FIG. 11 are the data source (“PCH”), and uniform record locator (“URL”) of a file transfer protocol (“FTP”) site 1120 from which a data feed or data feeds can be automatically accessed on a regular basis. Using this interface, a user can add new sources or locations of data from which additional data may be accessed. Activating the “add new” button of FIG. 11 leads a user to the “Add Feed Source” display of FIG. 12. The display contains only four input boxes: source name 1202, URL 1206, connect username 1204 and connect password 1208. Once a user enters this data, the feed source is contacted to ensure that access can be achieved through the information provided.

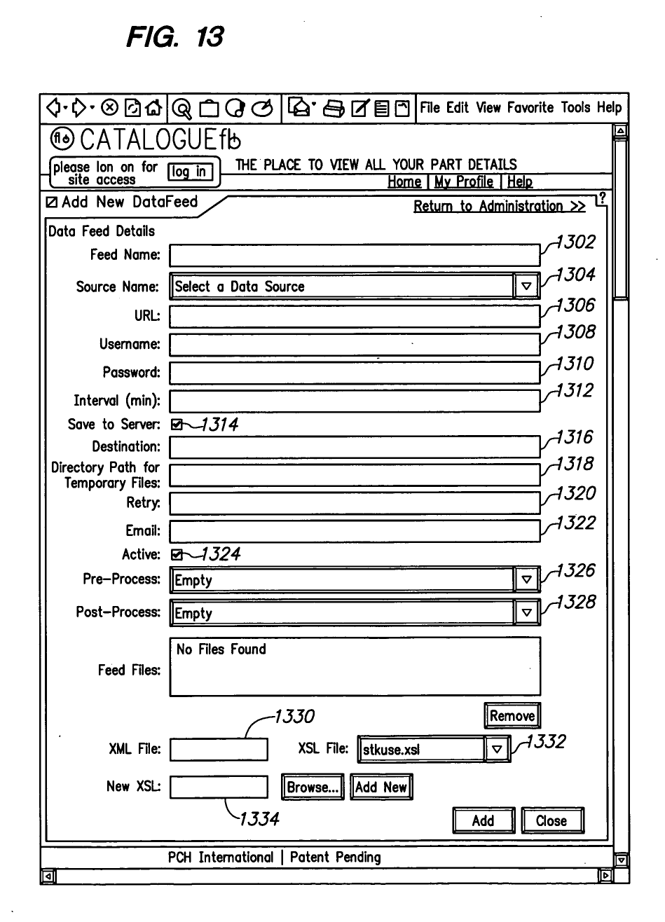

Returning to FIG. 10, a user may also directly add a particular data feed by activating the “Add New” button 1030, leading to the “Add New Data Feed” interface of FIG. 13. As shown, the user is prompted to enter several different feed parameters including feed name 1302, source name 1304, URL 1306, username 1308, and password 1310. If a feed has previously been identified, in an embodiment of the invention, selecting the source with which the feed is associated allows a user to automatically populate the URL 1306, username 1308, and password fields 1310 based on any previously provided feed inputs. The interface of FIG. 13 also prompts the user to input the time interval 1312 that determines the frequency with which the data feed is accessed, and for additional information about where status data from the data feed should be stored 1314-1318, where information about the status data may be sent 1332, and the pre- and post-process locations of the status data 1326 and 1328.

As shown the lower portion of FIG. 13, feed files and/or Extensible Markup Language (XML) files may be used to facilitate retrieval of the status data, as a data handler, formatted data request, or other set of instructions. With the interface, a user can specify an Extensible Stylesheet Language (XSL) document or file from a pull-down menu 1332 that contains instructions for processing the feed or XML file. XSL files can be added to this menu through a “New XSL:” input window 1334. Using these simple interfaces, a user, supplier, receiver, or other party can easily manipulate the flow of status data between nodes 210-214 and database 200 of FIG. 2A. However one of skill in the art will know that other interfaces, customized to different user environments, may also be used to provide the same functionality.

Linking to Tracking Display

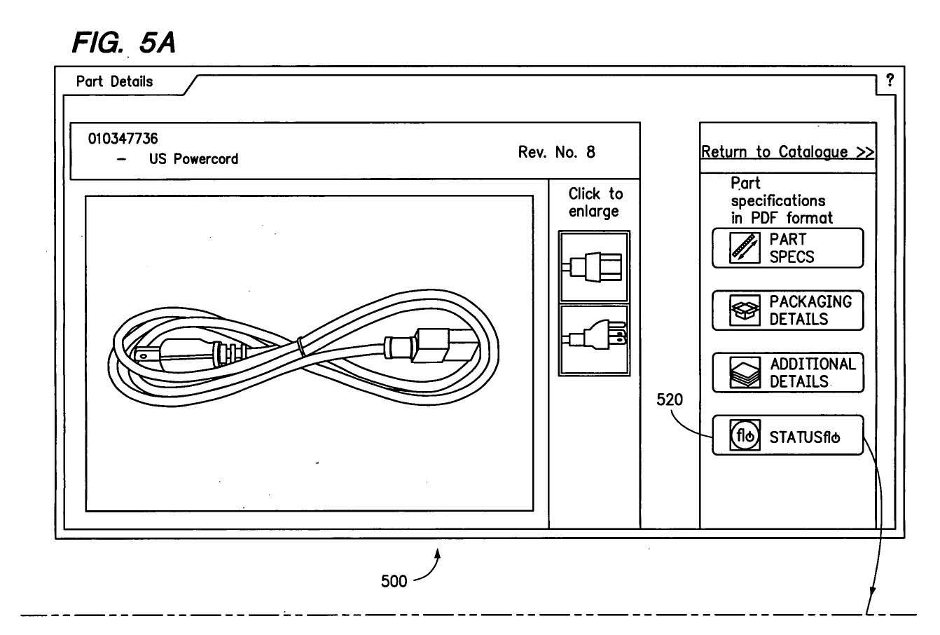

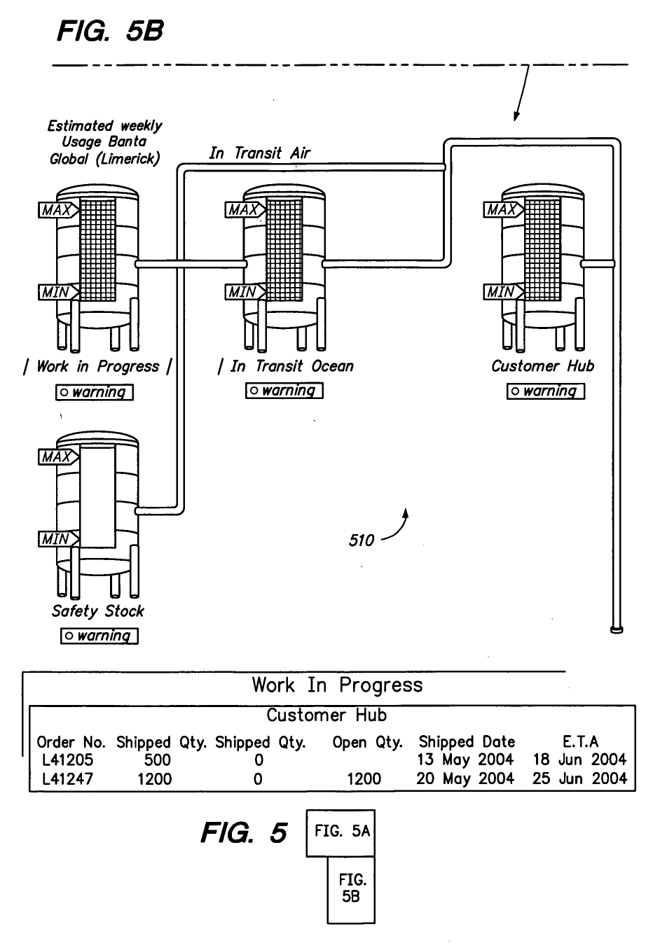

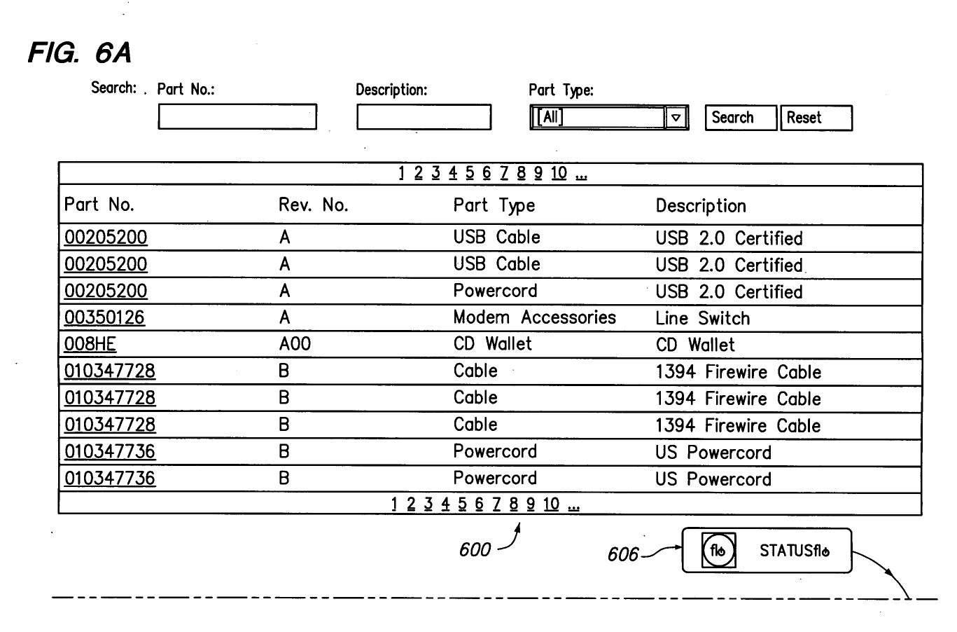

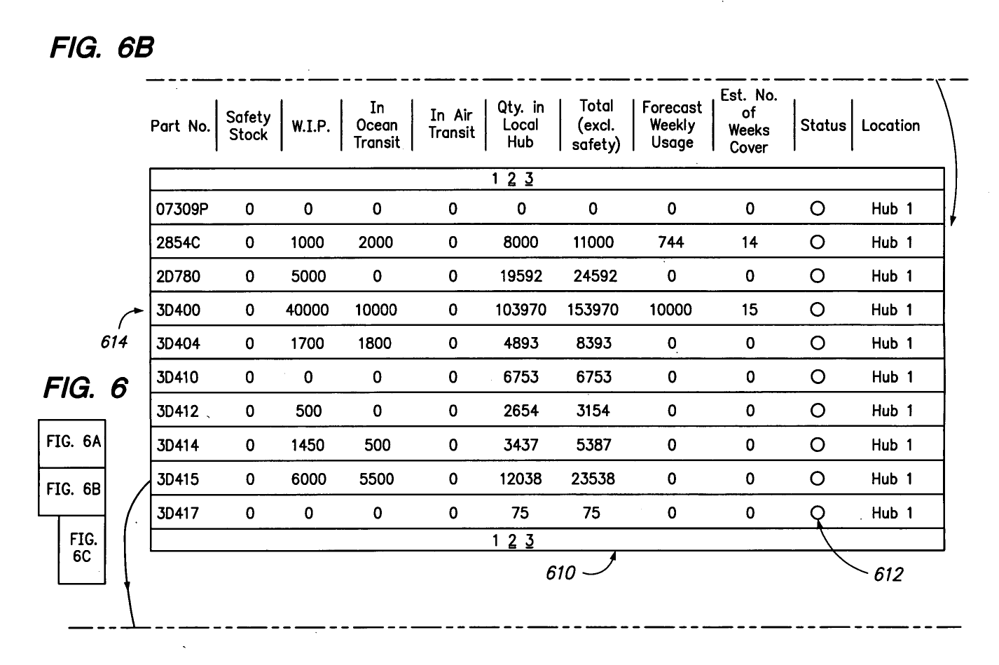

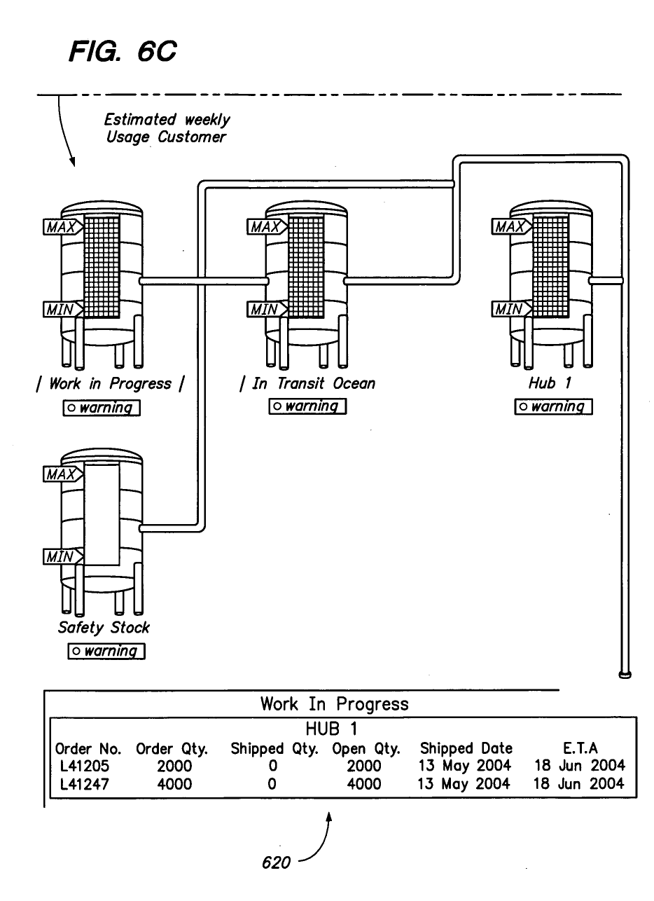

FIGS. 5 and 6 show the linking of parts catalogue displays to tracking displays in accordance with an embodiment of the invention. In an embodiment of the invention a user logs into a resource management portal (not shown). When logged in the user can browse a catalog of parts available for selection. If the user has active orders associated with a selected part, parts catalogue display 500 of FIG. 5 includes interface button 520 that allows the user to track the status of any active orders it has. Selection of button 520 launches tracking display 510, in which the status of active orders for the part, in the case of FIG. 5, a power cord, are visually depicted. By linking parts catalogue display 500 to tracking display 510 with a single click the user can efficiently navigate through the resource management portal and access specific order information using a minimal number of clicks.

Alternatively a user, once logged on, may prefer to view all open orders before drilling down on an individual item. Using the interfaces shown in FIG. 6, a user can view a display of all parts 600, then select a button 606 to be linked to a display of all open orders 610. In tabular format, display 610 shows open orders organized by part number, and the status of each part at a variety of nodes and categories including “W.I.P”, safety stock,” and “Total (excl. safety)”. A status indicator 612 resembling a flashing red light is provided to visually communicate to the user the violation of a pre-defined rule thus immediately signaling to the user which items require attention. Further detail can be obtained by selecting a part 614, thereby launching tracking display 620.

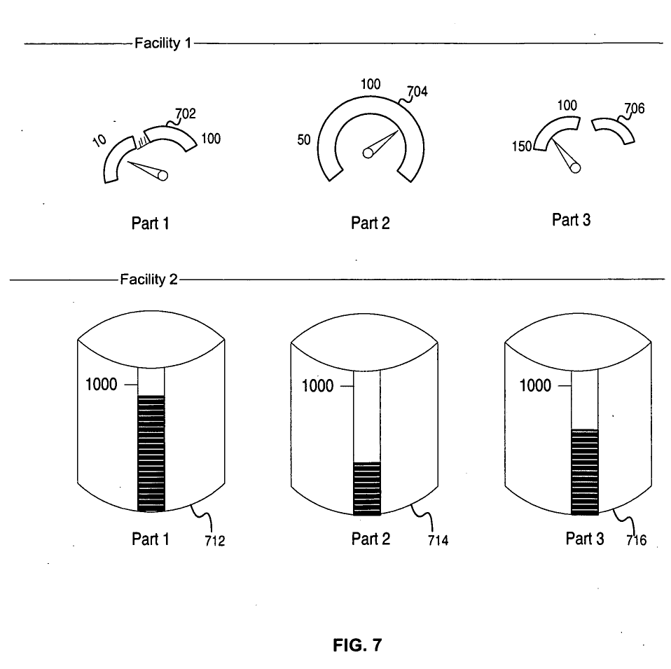

Although tracking displays 510, 620 of FIGS. 5 and 6 represent the status of specific ordered parts, FIG. 7 provides a simplified display that can be used to track more than one part sourced in a supply chain in accordance with another embodiment of the invention. The display of FIG. 7 contains two portions, the top representing Facility 1 and the bottom representing Facility 2 in a supply chain. Each facility represents a node on a supply chain where part inputs are assembled into finished goods. For each facility, three parts are being monitored (parts one, two, and three). Visually, dashboard indicators 702, 704, 706 represent the various parts being assembled at Facility 1 while images of supply containers 712, 714, 716 are used to portray inventory levels at Facility 2. Using such a tracking display allows a user to manage different as well as benchmark and monitor different, in this case redundant, nodes in a supply chain. In an embodiment the manufacturer orders the same component from different sources, to reduce the risk of supplier-based uncertainty, and can monitor the relative performance of each supplier using the display shown in FIG. 7.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

1. A tracking system for monitoring the status of a deliverable being provided to at least one receiver from at least one supplier, the system comprising:
a database containing status data about the deliverable, the status data sourced from a plurality of nodes, the plurality of nodes comprising at least a supplier node and a receiver node and representing a plurality of unaffiliated entities; and
a processing system configured to access the database to retrieve status data associated with the plurality of nodes and to generate a tracking display based on the retrieved status data, wherein the tracking display is a single-screen display that graphically represents the plurality of nodes and status data associated with each node.

2. The system of claim 1, further comprising a creation module for creating a template for a tracking display that specifies nodes in the display, a flow of a deliverable between the plurality of nodes, a format for the tracking display, and a data feed to source the tracking display with status data.

3. The system of claim 1, further comprising an event module for determining whether a pre-determined event has occurred, and, responsive to the occurrence of the event, carrying out an action.

4. The system of claim 3, wherein the event module is configured to parse status data stored in the database and analyze the parsed data to determine whether not an event has occurred as defined by a detection rule.

5. The system of 3, wherein the action comprises one from a group of: sounding a notification tone, outputting a message on the tracking display, and generating a message to be sent to a user.

6. The system of claim 1, further comprising a display management module for receiving user input to the tracking display and performing a pre-determined action based on the user input.

7. The system of claim 6, wherein the pre-determined action comprises one from a group of: changing a portion of the tracking display, providing additional information to the user, and launching a messaging interface for composing a message about the status data.

8. The system of claim 1, wherein the plurality of nodes further comprises at least one of: an intermediary node between the supplier node and the receiver node, and a repository node for storing a reserve of goods/services.

9. The system of claim 1, wherein the processing system is configured to generate a tracking display responsive to a request, and wherein content and format of the tracking display depends on whether this request is from the supplier node, the receiver node, an intermediary, or a third party.

10. The system of claim 1, wherein the status data comprises volume data about the deliverable being provided by the supplier to the receiver and data sourced from an automated inventory tracking system.

11. The system of claim 1, wherein the processing system is configured to generate a tracking display that graphically represents the plurality of nodes in the form of containers that are coupled by a grid and the status of the deliverable at a node in the form of a level in the container.

12. The system of claim 11, wherein a container includes an indicator of a minimum and a maximum threshold and the display comprises an indicator of whether the deliverable at a node exceeds a threshold.

13. A method for displaying status data, the method comprising:
receiving selections from a user regarding the format and content of a displayable output;
having status data about a component in a supply chain at a plurality of nodes in the supply chain;
storing the status data;
receiving a request for a displayable output;
responsive to the request, retrieving the status data; and
generating the displayable output, wherein the displayable output graphically represents the plurality of nodes and a status at each of the plurality of nodes.

14. The method of claim 13, wherein the step of retrieving is implemented through a command formatted in an XML or Web Services format.

15. The method of claim 13, further comprising generating a displayable output based on the status data and a fixed value, the displayable output depicting the relationship between the status data and the fixed value.

16. The method of claim 13, wherein receiving selections further comprises receiving a user selection in the form of an input to a graphical user interface wherein the graphical user interface comprises a pull-down menu.

17. The method of claim 13, wherein receiving selections further comprises receiving a location from which status data can be retrieved.

18. The method of claim 13, further comprising receiving a user input to the displayable output and taking a pre-determined action based on the user input.

19. The method of claim 13, further comprising:
determining based on the status data whether a pre-defined event has occurred; and
responsive to the occurrence of the pre-defined event, performing a pre-defined action.

20. The method of claim 19, wherein the pre-defined event comprises one of: exceeding a threshold, falling below a threshold, and activating a fault condition.

21. The method of claim 13, wherein the step of receiving a request for a displayable output includes receiving an indication of a requester as a supplier, intermediary, customer, supply chain manager, or third-party and wherein the step of generating the displayable output depends on whether the request was made by a supplier, intermediary, customer, supply chain manager, or third-party.

22. The method of claim 21, wherein the request is made by a supplier, and the plurality of nodes comprises a supplier node and an intermediary node.

23. The method of claim 21, wherein the request is made by a supply chain manager, and the plurality of nodes comprises a supplier node, an intermediary node, and a customer node.

24. The method of claim 13, wherein the step of generating the displayable output comprises generating a displayable output that includes a plurality of tanks to represent each of the plurality of nodes, an indicator on a tank to represent the status at a node, and an indicator on a tank to represent a threshold at a node.

25. The method of claim 24, wherein the step of generating the displayable output comprises generating a displayable output that includes the quantity of a good at a node, a usage of the good, and the remaining supply of the good based on the usage of the good.

26. The method of claim 24, wherein the step of generating the displayable output comprises generating a displayable output that includes a graphical indicator of the status at a node wherein the display color of the indicator reflects the status at the node.

27. The method of claim 19, wherein the step of determining comprises:
comparing status data to a predefined threshold to determine whether an event has occurred.

28. A tracking display for tracking the status of a deliverable in a supply chain, the display comprising:
a distinct graphical representation of each of a plurality of nodes including a supplier node, a customer node and a transit node and an indicator of the status of the deliverable at each node;
wherein the display shows status data from a plurality of separate and unaffiliated vendors.

29. A display for depicting stages in a process, the display comprising:
a first display area comprising graphical representations of a plurality of stages in the process wherein the status of the process at each stage is visually depicted with reference to a quantitative value; and
a second display area containing a table of values associated with the status of a stage in the process;
wherein activation of an item associated with a selected stage in the first display area causes the table in the second display area to display values corresponding to the status of the selected stage.

30. The display of claim 29, wherein the display is accessible in a single click from a catalogue of component parts.

31. The display of claim 29, further configured to convey a message based on the status data and baseline data about one from the group of: a usage level, a minimum threshold, and a maximum threshold.

32. The display of claim 29, further comprising an indicator of the remaining supply of the input at node calculated based on a projected usage.
